(19) United States
(12) Patent Application Publication
(10) Pub. No.: US 2006/0051721 A1
(43) Pub. Date: Mar. 9, 2006

(54) Improvements to orthodontic supports applicable to teeth

(76) Inventor: Luis Carriere Lluch, Barcelona (ES)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/535,614

(22) PCT Filed: Nov. 25, 2003
(86) PCT No.: PCT/ES03/00594

§ 371 Date: May 19, 2005

(30) Foreign Application Priority Data
Nov. 26, 2002 (ES) 200202713

(51) Int. Cl. A61C 3/00

(52) U.S. Cl. 433/10

(57) ABSTRACT

The invention relates to improvements which are applicable to supports comprising a base which is used to fit and fix the support to a tooth in a removable manner. Moreover, an upper body extends out from the aforementioned base, said body comprising a recess for the positioning of securing wire elements. The invention is characterized in that it comprises a sliding element which can slide in a guide on the body and which can be used to close the aforementioned recess, thereby enclosing the wire therein while remaining slidably connected to the part of the body comprising the recess for the securing wire. The invention also comprises elements which are used to retain the sliding element on the guide, defining stable open and closed positions for the securing wire recess.

### DESCRIPTIVE SUMMARY

This invention refers to improvements to orthodontic supports applicable to teeth, that is, the so-called “brackets” used in this medical type technology.

The improvements, which are the subject of this current invention, refer in particular to the so-called “brackets” which have retention devices for edge elements or wires intended for the interrelationship of said “brackets” among themselves and with other elements, for the purpose of allowing the desired function of the affected teeth. In particular, the improvements which are the subject of this current invention allow the closure element of the passing slot for the wire to be retained in a safe manner in a waiting position before completing the closure of said slot and thusly once said closure is effected.

To reach these objectives, the improvements which are the subject of this invention provide for the placement of a sliding closure element for the wire receiving slot which can be slid along the length of guide in the body of the “bracket” in a form fitted into a part of the slide or moving piece, having preferentially the form of an arc of a circle, remaining in said guide and also in the fitted part which is intended to coincide with same, each set of ridges and grooves allowing it to be connected to the next elastic retainer for the slide in a waiting position before the placement of the inter-relating wires of said “brackets” and another position from which the closure of said slot can be completed. The stability of the slide, which can move in either direction notably, facilitates the manipulation of the “bracket”.

In the same way, the “bracket” design complex facilitates a more rational use, reduction of weight and a structure that is more tolerated in regular use in the mouth cavity.

A different version of the invention, which is simpler, provides that the base of the support be given a longitudinal ridge, preferably in the shape of a dovetail, in whose upper edge are placed the profiles or ridges for the retention of the slide which, in this case, has a longitudinal slot fitted to the element on the base, sliding along the length of same and having at the bottom the shape of the conjugated profiles of the transverse ridges or grooves which are to hold the stable end positions of the slide in its movement, that is to say, the open and closed positions.

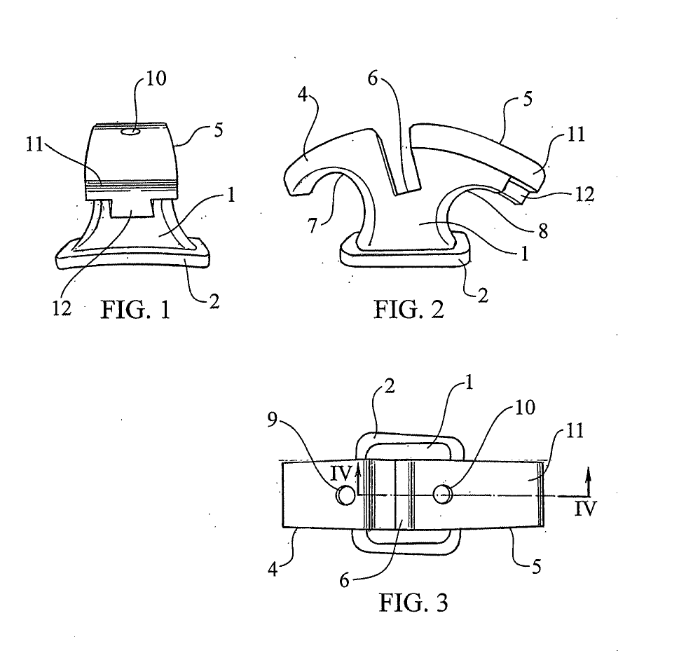

FIGS. 1, 2, and 3 are each illustrations of the front view, the lateral view and the top view of a tooth support piece for orthodontic purposes or “bracket” for these improvements.

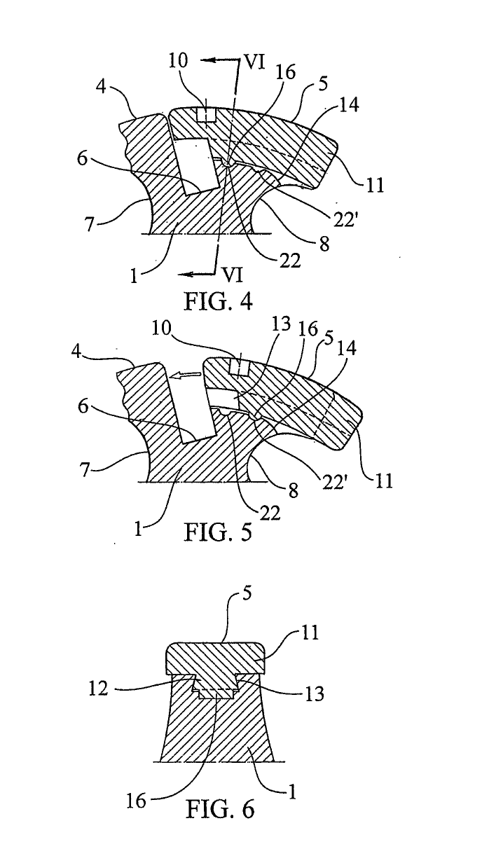

FIGS. 4, 5, and 6 are each cross-sectional views in the indicated planes showing the guiding arrangement and the retaining elements of the moving slide and the guide.

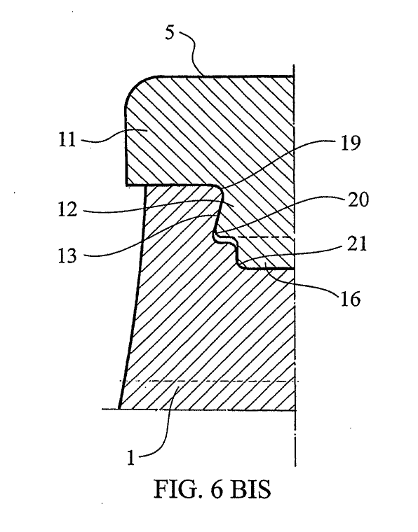

FIG. 6 following (page 3/11) shows a variation in the guide with dovetail.

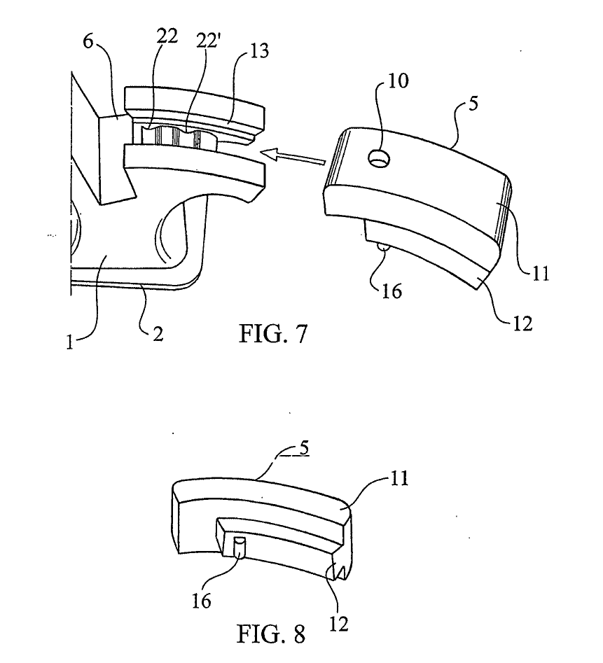

FIG. 7 shows in perspective the position of the moving slide and the guide at the moment of placement of the former.

FIG. 8 shows in perspective a view of the slide to be placed in the holder or “bracket”.

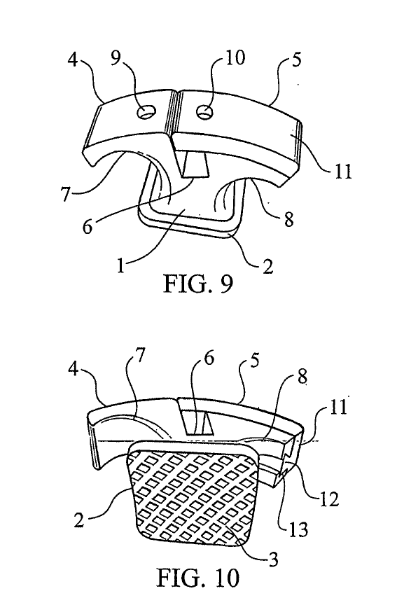

FIGS. 9 and 10 are each views of one of the retaining pieces in accordance with this invention, in perspective, in the closed position for holding the wire.

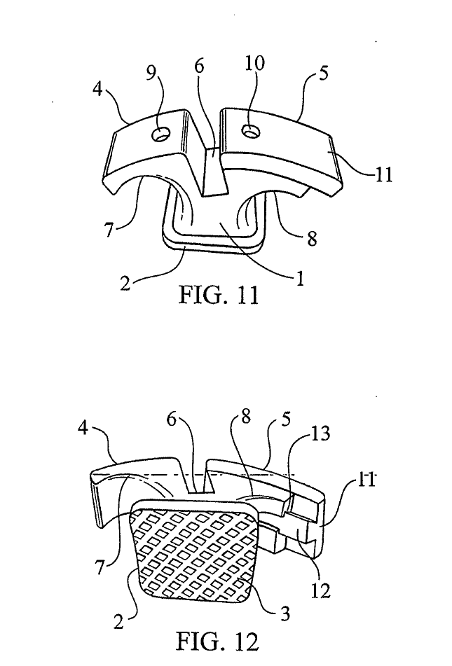

FIGS. 11 and 12 are similar views to those in FIGS. 9 and 10, with the piece or “bracket” open.

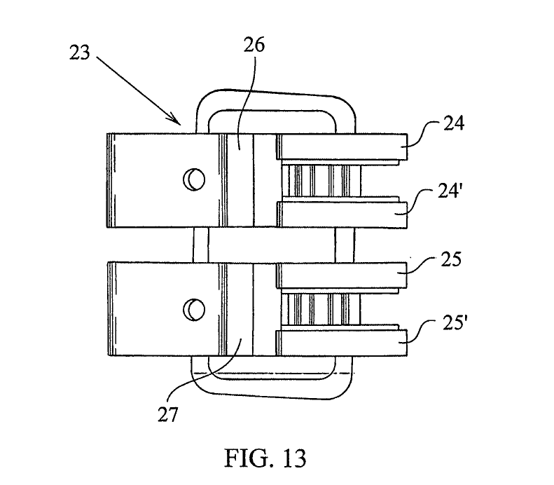

FIG. 13 shows a top view of a double type holding piece or “bracket” which incorporates the current improvements.

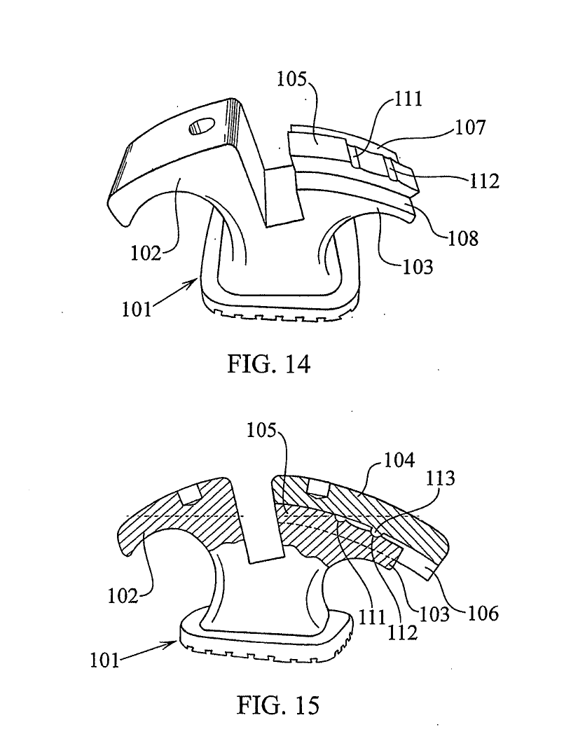

FIG. 14 shows a perspective view of a support piece for teeth for orthodontic purposes or “bracket” according to a variation of the current invention.

FIG. 15 shows a similar view to that of FIG. 14 with a longitudinal cross-section, showing the slide in the open position.

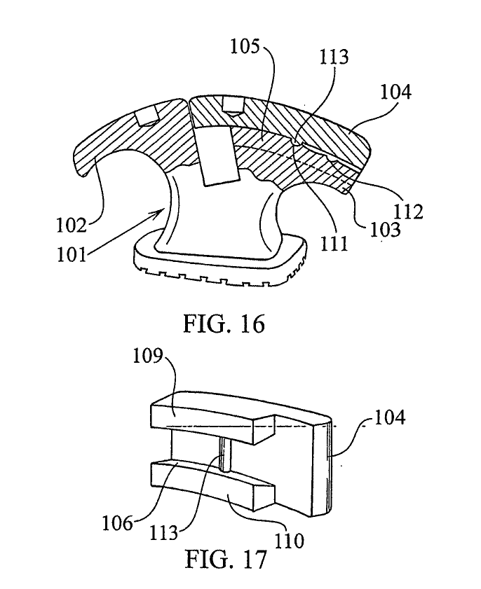

FIG. 16 is a view similar to that of FIG. 15 showing the slide in the closed position.

FIG. 17 shows a perspective view of the slide with the longitudinal guide to be fitted in the ridge of the base.

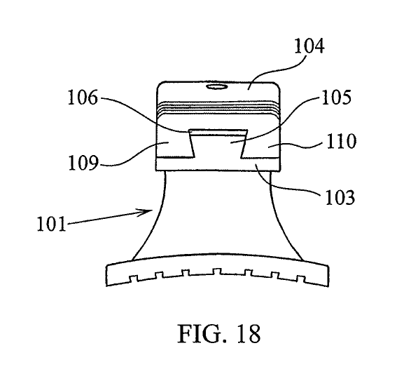

FIG. 18 shows a front view from one end.

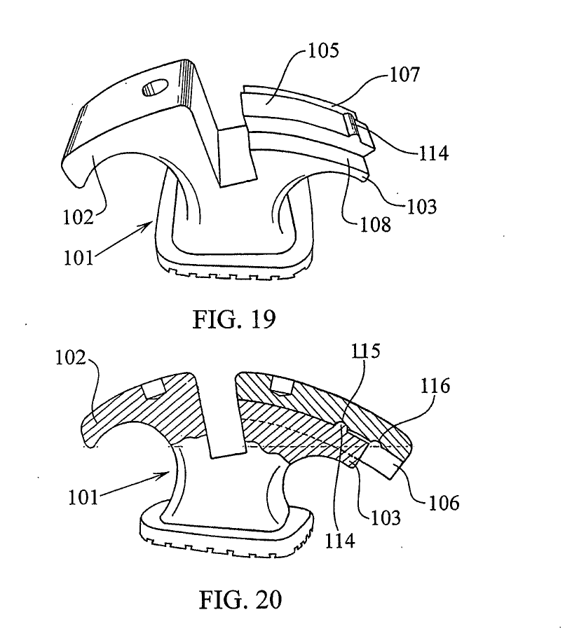

FIG. 19 shows a perspective view similar to FIG. 14 with the placement of a ridge for the retention of the slide at the extreme position.

FIG. 20 shows a view in longitudinal section of the base, showing the slide in the open position in the version corresponding to FIG. 19.

As can be seen in the figures, the “bracket” which is the object of this current improvement consists of a unitary body -1- of appropriate material, with a base -2- which has on its bottom a special adhering finish as can be seen as indicated by the number -3- in FIG. 10, having on top the anchoring zone for the edged elements or wires used to inter-relate different “brackets” among themselves composed of two arms -4- and -5- separated by a relatively deep slot -6- in which will be inserted said connecting wire.

As a set, body -1- has on its upper part an arched shape that affects arms -4- and -5- and wide slightly curved sides -7- and -8- that separate said arms from the lower part of said body. The base -2- is meant for adaptation to a tooth, for which purpose the finish -3- is intended to increase the adherence that is what allows the fixing of the “bracket” to one of the teeth involved by means of a special adhesive.

The curved upper parts of the arms -4- and -5- have seating parts of the type indicated with numbers -9- and -10-, for the introduction of a tool that will permit their easy manipulation.

Arm -5- has on its upper part a moveable slide -11- that can move along the length of a guide, which in the example shown has the noticeably curved shape of an arc of a circle, to allow the movement of said slide -11- from an open position represented in FIGS. 2 and 5 to a closed position, just as has been shown in FIGS. 3 and 4.

The guide for the slide -11- will be made, in accordance with the current improvements, with a simple or double dovetail structure, as can be seen in FIG. 6, in which the lower ridge of the guide -12- of the slide -11- shows the mentioned structure for its seating in a slot which accommodates it, as indicated by the number -13- in FIGS. 5 and 7.

The edges of the dovetail and of the corresponding guide may be rounded off to dissipate torsion forces, which otherwise could result in possible structural fractures, as has been shown in FIG. 6 bis with numbers -19-, -20-, and -21-.

By means of the arrangement shown, a very easy and precise guidance is made possible for the slide to determine the indicated positions, that is to say, the open and closed positions for the slot for the introduction of wires.

In order to allow the easy introduction of the slide -11- in the guide slot -13-, the latter shall have at its beginning a bevelled or curved entry zone -14-, to make possible an easy presentation of the slide -11-.

In order to obtain a firm and secure retention of the slide -11- in its two extreme positions, that is to say, of the closing and the opening of the curved side -6- for the introduction of the wire, the bottom of the guide slot -13- shall have smooth entry points, indicated by numbers -22- and -22′-, in which can fit the extrusion -16- from the lower part of the guide ridge -12- of the slide -11-. In this way, given sufficient elasticity in the materials employed, it is possible to retain the slide -11- in the two positions mentioned which correspond to the fitting of the ridge -16- in one or the other of the two grooves -22- and -23- previously indicated.

A variation of this current invention shall be composed of a double type “bracket”, just as has been shown in FIG. 13, in which the “bracket” -23- shows two pairs of arms parallel to each other -24-, -24′-, and -25-, 25′- constituted analogously to that described in FIGS. 1 to 12, where the curved sides can be seen placed parallel to each other -26- and -27- destined to hold the supporting wires.

In the variation portrayed in FIGS. 14 to 20 the form of a base -101- and arms -102- and -103- are provided both in their single and double versions, with the characteristic that the arm -103- which holds the slide -104- has on its upper side a ridge -105- which in cross-section fits into a groove -106- which runs longitudinally on the slide -104- so that the latter may move well guided by said ridge -105- and by the smooth areas -107- and -108- located laterally on the support -103- on each side of the ridge -105-.

With this disposition, the slide -104- will move along arm -103- with its groove -106- seated in a matched fit to ridge -105- and resting on its lateral edges, which have been shown with numbers -109- and -110- in FIG. -104-, on the upper face of the support which has ridge -105-.

To delimit the end positions of the slide, ridge -105- will have stops fitted to others on the slide to delimit the open position and the closed position. Thus, for example, in FIG. 14 the transverse grooves -111- and -112- have been shown as being able to receive the transverse ridge -113- on the slide -104- (FIG. 15), in order to delimit the open and closed positions.

In the version shown in FIGS. -106- and -107-, an inverse arrangement is provided in which the slot on the guide -105- has a transverse ridge -114- which fits the transverse grooves -115- and -116- on the slide -104- in order to determine the open and closed positions of the slide moving along the base piece.

It is desired to indicate that, as an example, while it has been shown that the receiving surface of the arm -103- upon which the slide -140- moves has a curved surface, it can also be done in a straight line if desired, conserving the rest of the characteristics provided in this invention.

The material for the fabrication of these supports shall be principally ceramic or polymer, but metals or alloys of them may also be used.

In the same way, these current improvements may be applied not only to the single support or “bracket” version but also to the double version.

1. Improvements on the orthodontic supports which can be applied to teeth, of the type which have a base for the adaptation and removable fixture to a tooth, and from which there extends a prolongation of an upper face with an inward curve for the placement of edged elements or support wires, characterized as having a moveable slide in a guide in the body able to close said inward curve and retain the wire in its interior, with the closing slide connected in a moveable way in the part of the body which has the inward curve for the introduction of the supporting wire, having retention elements on the slide on the guide which delimit stable open and closed positions on the receiving inward curve for the support wire.

2. Improvements on the orthodontic supports that can be applied to teeth, according to claim 1, characterized as having the guide for the slide on the body of the piece to be fixed upon the tooth to be established by means of a male and female guide in single or double dovetail.

3. Improvements in the orthodontic supports which can be applied to teeth, according to claim 2, characterized as having edges of the dovetailing and the corresponding guide which can be rounded off to dissipate torsion forces.

4. Improvements in the orthodontic supports which can be applied to teeth, according to claim 1, characterized as having a means of retention for the slide in stable open and closed positions for the inward curve which carries the wire, to be established by means of a ridge in one of said fitted pieces and each having a groove in the other to allow, by reason of the elasticity of the material, the retention of the slide in the corresponding stable open and closed position in the inward curving receptor of the support wire.

5. Improvements in the orthodontic supports which can be applied to teeth, according to claim 1, characterized as having a base which on its top has two mutually parallel bodies, each one of which has its corresponding inward curving receptor of wire and its slide with the capacity to be retained in the open and closed position.

6. Improvements in the orthodontic supports that can be applied to teeth, according to claim 1, characterized as having the structure of the upper part of the body with a generally arched shape with the convexity directed outwards.

7. Improvements in the orthodontic supports that can be applied to teeth, according to claim 1, characterized as having the guide of the body and the fitted element of the slide with a generally arched form of a circle in the longitudinal sense, allowing their mutually coordinated movement.

8. Improvements in the orthodontic supports that can be applied to teeth, according to claim 1, characterized as having the upper part of the body showing various cavities on each side of the inward curving area that carries the wires, in order to allow for manipulation.

9. Improvements in the orthodontic supports which can be applied to teeth, according to claim 1, characterized as having the closing slide with a longitudinal slot able to be guided on a longitudinal ridge in a fitted way to the base of adaptation and fixation to the tooth, each of said guide grooves and longitudinal ridges having an internal fit to limit the open and closed positions of the slide with respect to the supporting base.

10. Improvements in the orthodontic supports which can be applied to teeth, according to claim 1, characterized as having limiting stops for the open and closed positions to be done by transverse grooves in the base guide and a ridge in the bottom of the slot on the slide, whose fit with said grooves determines the open and closed positions of the slide.

11. Improvements in the orthodontic supports that can be applied to teeth, according to claim 1, characterized as having stops to determine the open and closed positions of the slide by means of a transverse ridge in the base guide and with each transverse groove in the bottom of the longitudinal slot of the slide able to fit with said respective transverse ridge in the open and closed positions of the slide.

12. Improvements in the orthodontic supports that can be applied to teeth, according to claim 1, characterized as having a receptor base for the moving slide, and the slide itself that have in a fitted way a groove and a ridge which coincide for a guide which can be adopted with a straight form.

13. An orthodontic bracket having a base for attachment to a tooth and a pair of arm members extending from said base in an outward direction and defining an archwire slot between them, at least one of said arm members having an outwardly convex curved shape and including a receiving slot, and a corresponding curved slide member having a guide for slidable engagement with said receiving slot, wherein the slide member has a length sufficient to bridge said archwire slot so as to retain an archwire therein.

14. The orthodontic bracket of claim 13 wherein said receiving slot has a shape for slidingly mating with a dovetail shape on said guide.

15. The orthodontic bracket of claim 13 wherein the outwardly curved convex shape of the arm member is an arc of a circle.

16. The orthodontic bracket of claim 14 wherein said slide member includes retaining tabs for cooperatively mating with recesses in said arm member to hold said slide member in a closed position spanning said archwire slot.

17. The orthodontic bracket of claim 14 wherein said arm member including said receiving slot includes retaining tabs for cooperatively mating with recesses in said slide member to hold said slide member in one of an open and a closed position spanning said archwire slot.

18. The orthodontic bracket of claim 13 wherein at least one of said slide member and said arm member opposite said archwire slot from said slide member include a recess for the introduction of a tool for manipulation of said orthodontic bracket.

19. An orthodontic bracket having a base for attachment to a tooth, a first pair of arm members extending from said base in an outward direction and defining an archwire slot between them, and a second pair of arm members substantially parallel to said first pair and likewise extending from said base in an outward direction and defining said archwire slot between them, each of said first pair and second pair comprising at least one arm member having an outwardly convex curved shape and including a receiving slot, and a corresponding curved slide member having a guide for slidable engagement with said receiving slot, wherein the slide member has a length sufficient to bridge said archwire slot so as to retain an archwire therein.

20. The orthodontic bracket of claim 19 wherein said receiving slot has a shape for slidingly mating with a dovetail shape on said guide.
